(19) United States
(12) Patent Application Publication
(10) Pub. No.: US 2017/0219787 A1
(43) Pub. Date: Aug. 3, 2017

(54) Communication Module

(71) Applicant: APRESIA Systems, Ltd., Tokyo (JP)

(72) Inventors: Akira OGURA, Hitachi (JP); Kinya YAMAZAKI, Hitachi (JP); Masataka SATO, Yasugi (JP); Shinji KOMATSUZAKI, Mito (JP)

(21) Appl. No.: 15/422,975

(22) Filed: Feb. 2, 2017

(30) Foreign Application Priority Data
Feb. 3, 2016 (JP) 2016-019267

(51) Int. Cl. G02B 6/42

(52) U.S. Cl. CPC G02B 6/4272; G02B 6/428; G02B 6/4257; G02B 6/4246

(57) ABSTRACT

A characteristic of an optical element, especially a high frequency characteristic, installed in a communication module is improved. The communication module has: a first and second front surface side metal layers provided on a front surface of a module substrate and electrically separated from each other; a first and second rear surface side metal layers provided on a rear surface of the module substrate and electrically separated from each other; a first thermal via bored through the module substrate and thermally connecting the first front and rear surface side metal layers; and a second thermal via bored through the module substrate and thermally connecting the second front and rear surface side metal layers. A driving IC is mounted on and thermally connected to the first front surface side metal layer. A light emitting element is mounted on and thermally connected to the second front surface side metal layer.

### CROSS-REFERENCE TO RELATED APPLICATION

The present application claims priority from Japanese Patent Application No. 2016-019267 filed on Feb. 3, 2016, the content of which is hereby incorporated by reference into this application.

### TECHNICAL FIELD OF THE INVENTION

The present invention relates to a communication module, and in particular relates to a communication module provided with a photoelectric conversion function.

### BACKGROUND OF THE INVENTION

A general communication module comprises: a housing provided with a connector; and a substrate housed in the housing and electrically connected to the connector installed in the housing. The substrate installed in the communication module is generally called as “module substrate” which is distinguished from a substrate (generally called as “host board” or “mother board”) installed in a communication device such as a network switch or a server to which the communication module is connected. Hereinafter, in accordance with the distinction described above, the substrate installed in the communication module may be called as “module substrate”, and the substrate installed in the communication device to which the communication module is connected may be called as “mother board”.

Mounted on the module substrate is an optical element (light emitting element or light receiving element) or an electronic part. For example, on the module substrate, alight emitting element such as a VCSEL (Vertical Cavity Surface Emitting Laser) and a driving IC (Integrated Circuit) which drives the light emitting element are mounted; and further a light receiving element such as a PD (Photodiode) and an amplifying IC (Integrated Circuit) which amplifies a signal outputted from the light receiving element are mounted. Inmost cases, the light emitting element and the driving

IC are electrically connected via a pair of bonding wires, and the light receiving element and the amplifying IC are electrically connected via another pair of bonding wires.

A multilayer substrate is mostly used for the module substrate as described above, and the optical element or the electronic part is mounted on one surface of the multilayer substrate. Here, each of the optical element and the electronic part mounted on the one surface of the multilayer substrate generates heat in operation. Thus, a heat absorbing surface may be provided on the one surface (front surface) of the multilayer substrate on which the optical element or the electronic part is mounted, and a heat dissipating surface may be provided on another surface (rear surface) of the multilayer substrate. In this case, a plurality of vias called “thermal vias” are formed in the multilayer substrate, and the heat absorbing surface and the heat dissipating surface are thermally connected via these thermal vias. The optical element or the electronic part is mounted on the heat absorbing surface and thermally connected to the heat absorbing surface. Heat emitted from the optical element or the electronic part mounted on the heat absorbing surface is transmitted to the heat dissipating surface via the thermal vias, and the heat is dissipated from the heat dissipating surface to air or transmitted to the housing via the heat dissipating surface. For example, Japanese Patent Application Laid-Open No. 2015-92524 is referred to as Patent Document 1.

### SUMMARY OF THE INVENTION

The heat absorbing surface and the heat dissipating surface as described above are formed by metal layers provided on the multilayer substrate. Specifically, the multilayer substrate is provided with a plurality of the metal layers and insulation layers alternately laminated, and the heat absorbing surface is formed by the top metal layer and the heat dissipating surface is formed by the bottom metal layer.

On the other hand, in most cases, a bottom surface of the optical element or the electronic part is formed as ground. Thus, when the optical element and the electronic part are mounted on the heat absorbing surface, the optical element and the electronic part are not only thermally connected to the heat absorbing surface but also electrically connected to the heat absorbing surface, and therefore an inadvertent electric current path is generated. For example, the light emitting element and the driving IC mounted on the heat absorbing surface are electrically connected via the pair of the bonding wires, and one bonding wire forms a + (plus) side electric current path and the other bonding wire forms a − (minus) side electric current path. However, when the light emitting element and the driving IC are electrically connected via the heat absorbing surface, the − (minus) side electricity path is additionally formed between the light emitting element and the driving IC. As a result, one + side electric current path and two − side electric current paths are formed between the light emitting element and the driving IC, and therefore electrical unbalance is generated and a characteristic of the light emitting element, especially a high frequency characteristic, is deteriorated.

An object of the present invention is to improve a characteristic of a light emitting element, especially a high frequency characteristic, installed in a communication module.

A communication module according to the present invention includes: a multilayer substrate; an electronic part and an optical element mounted on the multilayer substrate; a first front surface side metal layer provided on a front surface of the multilayer substrate; a second front surface side metal layer provided on the front surface of the multilayer substrate and electrically separated from the first front surface side metal layer; a first rear surface side metal layer provided on a rear surface of the multilayer substrate; a second rear surface side metal layer provided on the rear surface of the multilayer substrate and electrically separated from the first rear surface side metal layer; a first thermal via which is bored through the multilayer substrate and thermally connects the first front and rear surface side metal layers; and a second thermal via which is bored through the multilayer substrate and thermally connects the second front and rear surface side metal layers. The electronic part is mounted on and thermally connected to the first front surface side metal layer, and the optical element is mounted on and thermally connected to the second front surface side metal layer.

In one embodiment according to the present invention, the optical element is formed as a light emitting element, and the electronic part is formed as a driving IC which drives the light emitting element.

In another embodiment according to the present invention, the multiplayer substrate has a plurality of insulation layers and inner metal layers alternately laminated between the first front and rear surface side metal layers and between the second front and rear surface side metal layers. One part of the inner metal layer electrically connected to the first front and rear surface side metal layers is electrically separated from the other part of the inner metal layer electrically connected to the second front and rear surface side metal layers.

In yet another embodiment according to the present invention, the communication module has : a third front surface side metal layer provided on the front surface of the multilayer substrate and electrically separated from the first and second front surface side metal layers; and a light receiving element mounted on and thermally connected to the third front surface side metal layer.

According to the present invention, the characteristic of the optical element, especially the high frequency characteristic, installed in the communication module can be improved.

### BRIEF DESCRIPTIONS OF THE DRAWINGS

FIG. 1 is a perspective view illustrating one example of a communication module to which the present invention is applied;

FIG. 2A is a plane view illustrating a schematic configuration of a photoelectric conversion part provided on a module substrate;

FIG. 2B is aside view illustrating a schematic configuration of a photoelectric conversion part provided on a module substrate;

FIG. 3A is a plane view illustrating a heat absorbing surface provided on a front surface of the module substrate;

FIG. 3B is a plane view illustrating a heat dissipating surface provided on a rear surface of the module substrate;

FIG. 4 is a cross-sectional view taken along line X-X in FIG. 3A;

FIG. 5 is a cross-sectional view illustrating a modified example of the module substrate; and

FIG. 6A is a plane view illustrating one example of the heat absorbing surface provided on the front surface of the module substrate; and

FIG. 6B is a plane view illustrating another example of the heat absorbing surface provided on the front surface of the module substrate.

### DESCRIPTIONS OF THE PREFERRED EMBODIMENTS

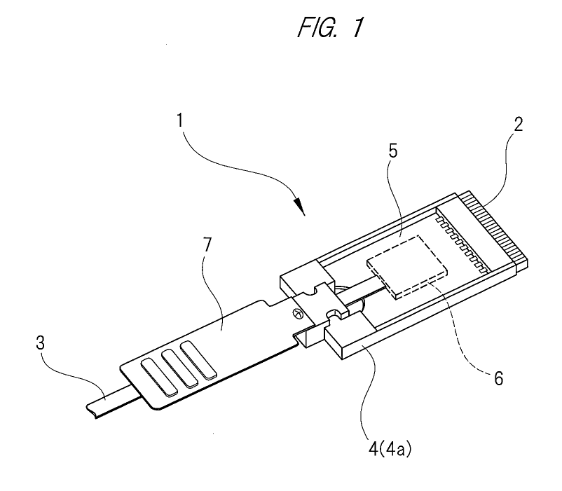

Hereinafter, one example of embodiments according to the present invention will be described. A communication module 1 shown in FIG. 1 is connected to a mother board installed in a communication device not shown so as to convert an optical signal into an electric signal and convert the electric signal into the optical signal. A plug connector 2 is provided at a tip end of the communication module 1, and the plug connector 2 is connected to a receptacle connector provided on the mother board. Namely, the communication module 1 according to the present embodiment has the plug connector 2 insertable to and removable from the receptacle connector provided on the mother board, and the communication module 1 and the mother board are connected via the plug connector 2 and the receptacle connector.

A communication semiconductor chip is mounted on the mother board to which the communication module 1 is connected as described above, and the communication module 1 connected to the mother board is connected to the communication semiconductor chip via a wiring formed on the mother board. Further, a plurality of the receptacle connectors are provided on the mother board, and the communication modules 1 are connected to the communication semiconductor chip via the respective receptacle connectors.

The communication module 1 has a housing 4 into which one end of an optical fiber (fiber ribbon) 3 is drawn, and a multilayer substrate 5 housed in the housing 4. A photoelectric conversion part 6 is provided on the multilayer substrate 5. In the description below, the multilayer substrate 5 is called as “module substrate 5”. Further, the housing 4 is formed of a lower side case 4a which is shown in the drawing, and an upper side case which is not shown in the drawing. The lower side case 4a and the upper side case are abutted against each other so as to form the housing 4 having a space which can house the module substrate 5.

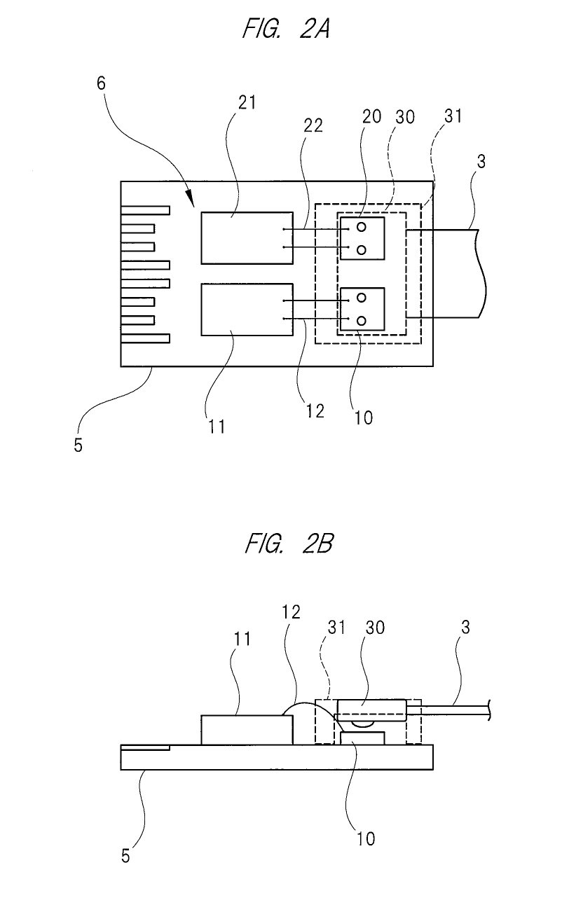

Although illustration is omitted in FIG. 1, the photoelectric conversion part 6 provided on the module substrate 5 is formed of an optical element and an electronic part mounted on a front surface of the module substrate 5. As shown in FIG. 2A, the photoelectric conversion part 6 includes a light emitting element 10 which is one of the optical elements, and a driving IC 11 which is one of the electronic parts and drives the light emitting element 10. Further, the photoelectric conversion part 6 includes a light receiving element 20 which is another one of the optical elements, and an amplifying IC 21 which is another one of the electronic parts and amplifies an electric signal outputted from the light receiving element 20. The light emitting element 10 and the driving IC 11 are electrically connected via a pair of bonding wires 12, and the light receiving element 20 and the amplifying IC 21 are electrically connected via another pair of the bonding wires 22.

Further, as shown in FIG. 2B, a lens block 30 which optically connects the light emitting element 10 and the light receiving element 20 (FIG. 2A) with the optical fiber 3 is also provided on the front surface of the module substrate 5. The lens block 30 is fixed on the module substrate 5 via a support member 31 and arranged above the light emitting element 10 and the light receiving element 20 (FIG. 2A) so as to cover them.

As shown in FIG. 1, the one end of the optical fiber 3 is drawn into the housing 4. The one end of the optical fiber 3 drawn into the housing 4 is optically connected to the lens block 30 shown in FIGS. 2A and 2B via a MT (Mechanically Transferable) connector not shown. Specifically, a tip end surface of the MT connector is abutted against an abutting surface of the lens block 30. Further, a pair of guide pins is protruded from the abutting surface of the lens block 30, and the guide pin is inserted into a guide hole formed in the tip end surface of the MT connector. Further, in the present embodiment, a VCSEL (Vertical Cavity Surface Emitting Laser) is used for the light emitting element 10 shown in FIG. 2A, and a PD (Photodiode) is used for the light receiving element 20 shown in FIG. 2A. However, the light emitting element 10 and the light receiving element 20 are not limited to the specific light emitting element and the specific light receiving element. Further, as shown in FIG. 1, a pull tab 7 which is held when the plug connector 2 is removed from the receptacle connector is mounted to a rear end of the housing 4.

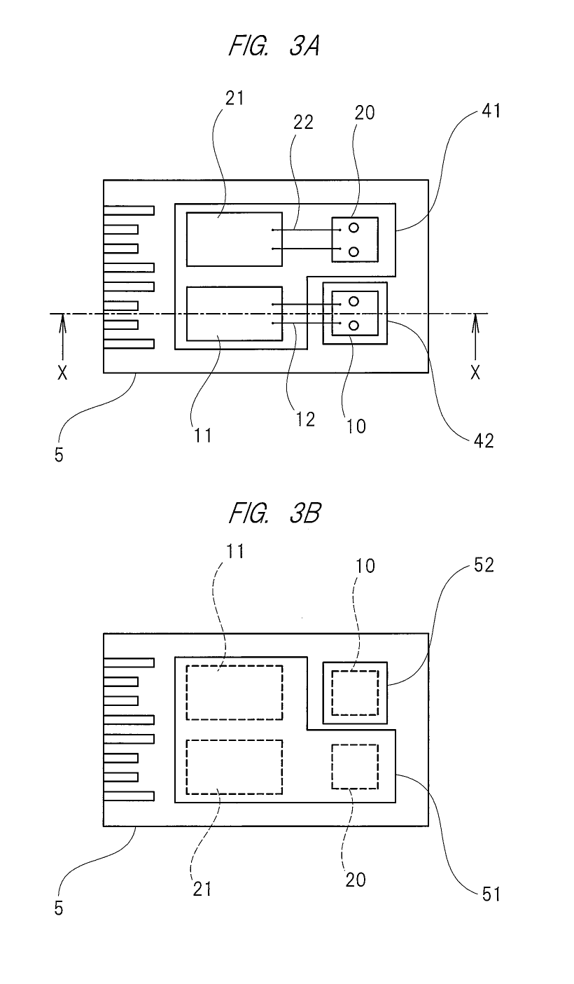

As shown in FIG. 3A, a first front surface side metal layer 41 and a second front surface side metal layer 42 are provided on the front surface of the module substrate 5. On the other hand, as shown in FIG. 3B, a first rear surface side metal layer 51 and a second rear surface side metal layer 52 are provided on a rear surface of the module substrate 5.

As shown in FIG. 3A, the first front surface side metal layer 41 and the second front surface side metal layer 42 are provided on the same plane although independent from each other, and therefore the first front surface side metal layer 41 and the second front surface side metal layer 42 are electrically separated from each other. As shown in FIG. 3B, the first rear surface side metal layer 51 and the second rear surface side metal layer 52 are provided on the same plane although independent from each other, and therefore the first rear surface side metal layer 51 and the second rear surface side metal layer 52 are electrically separated from each other.

As referred to FIG. 3A again, the driving IC 11, the amplifying IC 21, and the light receiving element 20 are mounted on the first front surface side metal layer 41, and the light emitting element 10 is mounted on the second front surface side metal layer 42. Namely, electrically separated and different from each other are the two metal layers, on one of which the driving IC 11, the amplifying IC 21, and the light receiving element 20 are mounted, and on the other of which the light emitting element 10 is mounted.

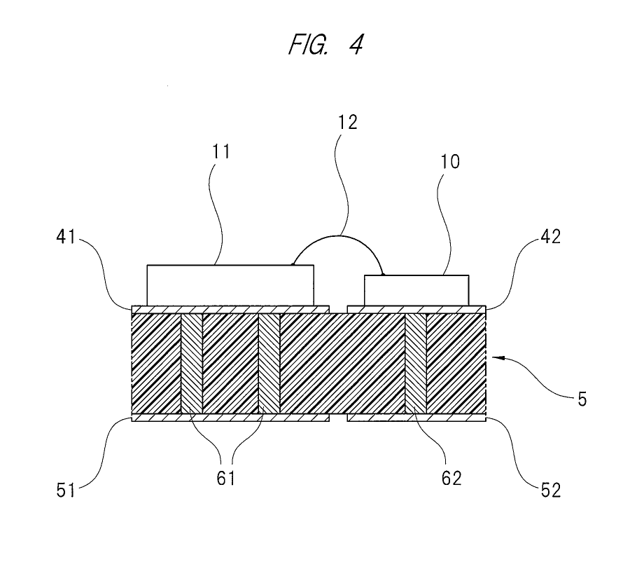

As shown in FIG. 4, a bottom surface of the driving IC 11 mounted on the first front surface side metal layer 41 is contacted with the first front surface side metal layer 41, and the driving IC 11 is thermally connected to the first front surface side metal layer 41. Further, the bottom surface of the driving IC 11 is formed as ground, and the driving IC 11 is also electrically connected to the first front surface side metal layer 41. Although it is not shown in FIG. 4, the light receiving element 20 and the amplifying IC 21 shown in FIG. 3A are also thermally and electrically connected to the first front surface side metal layer 41.

On the other hand, a bottom surface of the light emitting element 10 mounted on the second front surface side metal layer 42 is contacted with the second front surface side metal layer 42, and the light emitting element 10 is thermally connected to the second front surface side metal layer 42. Further, the bottom surface of the light emitting element 10 is formed as ground, and the light emitting element 10 is also electrically connected to the second front surface side metal layer 42.

Further, the first front surface side metal layer 41 and the first rear surface side metal layer 51 are thermally connected via first thermal vias 61 which are bored through the module substrate 5. Similarly, the second front surface side metal layer 42 and the second rear surface side metal layer 52 are thermally connected via a second thermal via 62 which is bored through the module substrate 5.

The heat emitted from the driving IC 11 is transmitted to the first rear surface side metal layer 51 via the first front surface side metal layer 41 and the first thermal vias 61. The first rear surface side metal layer 51 is thermally connected to the bottom surface of the housing 4 shown in FIG. 1 via a thermal sheet not shown. Thus, the heat emitted from the driving IC 11 is transmitted to the bottom surface of the housing 4 through the first front surface side metal layer 41, the first thermal vias 61, the first rear surface side metal layer 51, and the thermal sheet in this order. The heat which reaches the bottom surface of the housing 4 is dissipated from a surface of the housing 4 to air.

The heat emitted from the light emitting element 10 is transmitted to the second rear surface side metal layer 52 via the second front surface side metal layer 42 and the second thermal via 62. The second rear surface side metal layer 52 is thermally connected to the bottom surface of the housing 4 shown in FIG. 1 via the common thermal sheet with the first rear surface side metal layer 51. Thus, the heat emitted from the light emitting element 10 is transmitted to the bottom surface of the housing 4 through the second front surface side metal layer 42, the second thermal via 62, the second rear surface side metal layer 52, and the thermal sheet in this order. The heat which reaches the bottom surface of the housing 4 is dissipated from the surface of the housing 4 to air.

In this way, the first front surface side metal layer 41 functions as a heat absorbing surface in the relation with the driving IC 11, and the first rear surface side metal layer 51 functions as a heat dissipating surface in the relation with the driving IC 11. Further, the second front surface side metal layer 42 functions as a heat absorbing surface in the relation with the light emitting element 10, and the second rear surface side metal layer 52 functions as a heat dissipating surface in the relation with the light emitting element 10.

Here, the bottom surface of the driving IC 11 formed as the ground of the driving IC 11 is electrically connected to the first front surface side metal layer 41; the bottom surface of the light emitting element 10 formed as the ground of the light emitting element 10 is electrically connected to the second front surface side metal layer 42; and these configurations are already described above. Namely, the first front surface side metal layer 41 also functions as a ground layer in the relation with the driving IC 11, and the second front surface side metal layer 42 also functions as a ground layer in the relation with the light emitting element 10. However, the first front surface side metal layer 41 and the second front surface side metal layer 42 are electrically separated from each other. Thus, the second front surface side metal layer 42 formed as the ground layer of the light emitting element 10 is formed as a ground layer dedicated to the light emitting element electrically insulated from the first front surface side metal layer 41 formed as the ground layer of the driving IC 11.

As described above, in the present embodiment, the first front surface side metal layer 41 functioning as the ground layer of the driving IC 11, and the second front surface side metal layer 42 functioning as the ground layer of the light emitting element 10 are electrically separated. Thus, any electric current path is not formed between the driving IC 11 and the light emitting element 10 by the metal layer. In other words, the driving IC 11 and the light emitting element 10 are electrically connected only by the pair of the bonding wires 12. Thus, the characteristic of the light emitting element 10, especially the high frequency characteristic, is enhanced.

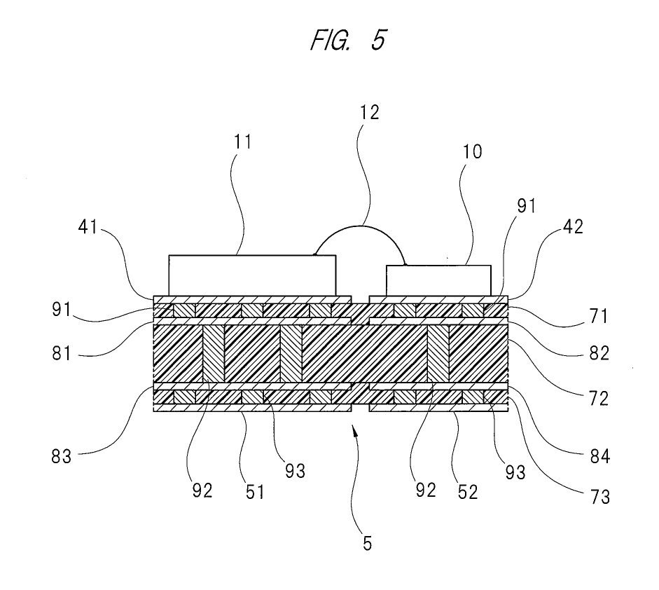

The present invention is not limited to the embodiments described above, and various modifications can be made without departing from the scope of the subject matter thereof. For example, the module substrate 5 according to the embodiment described above is formed as a two-layer substrate, only on the front and rear surfaces of which the metal layers are provided. However, the module substrate 5 can be replaced with a multilayer substrate with more than three layers, also in an inner layer of which the metal layer(s) is(are) provided. For example, the module substrate 5 can be replaced with a four-layer substrate shown in FIG. 5. The module substrate 5 shown in FIG. 5 has a plurality of insulation layers and inner metal layers alternately laminated between the first front surface side metal layer 41 and the first rear surface side metal layer 51 and between the second front surface side metal layer 42 and the second rear surface side metal layer 52. Specifically, a first insulation layer 71 is provided below the first front surface side metal layer 41 and the second front surface side metal layer 42; and a first inner metal layer 81 and a second inner metal layer 82 are provided below the first insulation layer 71. Further, a second insulation layer 72 is provided below the first inner metal layer 81 and the second inner metal layer 82; and a third inner metal layer 83 and a fourth inner metal layer 84 are provided below the second insulation layer 72. In addition, a third insulation layer 73 is provided below the third inner metal layer 83 and the fourth inner metal layer 84; and the first rear surface side metal layer 51 and the second rear surface side metal layer 52 are provided below the third insulation layer 73.

Each of the first insulation layer 71, the second insulation layer 72, and the third insulation layer 73 shown in FIG. 5 is formed by a series of resin layers. On the other hand, the first inner metal layer 81 and the second inner metal layer 82 are provided on the same plane (the same layer), but the first inner metal layer 81 and the second inner metal layer 82 are formed as discontinuous metal layers electrically separated from each other. Similarly, the third inner metal layer 83 and the fourth inner metal layer 84 are provided on the same plane (the same layer), but the third inner metal layer 83 and the fourth inner metal layer 84 are formed as discontinuous metal layers electrically separated from each other.

Further, the first front surface side metal layer 41 and the first inner metal layer 81 are thermally and electrically connected via upper thermal vias 91 which are bored through the first insulation layer 71; the first inner metal layer 81 and the third inner metal layer 83 are thermally and electrically connected via intermediate thermal vias 92 which are bored through the second insulation layer 72; and the third inner metal layer 83 and the first rear surface side metal layer 51 are thermally and electrically connected via lower thermal vias 93 which are bored through the third insulation layer 73.

Further, the second front surface side metal layer 42 and the second inner metal layer 82 are thermally and electrically connected via other upper thermal vias 91 which are bored through the first insulation layer 71; the second inner metal layer 82 and the fourth inner metal layer 84 are thermally and electrically connected via another intermediate thermal via 92 which is bored through the second insulation layer 72; and the fourth inner metal layer 84 and the second rear surface side metal layer 52 are thermally and electrically connected via other lower thermal vias 93 which are bored through the third insulation layer 73.

Namely, a part of the inner metal layers (the first inner metal layer 81 and the third inner metal layer 83) electrically connected to the first front surface side metal layer 41 and the first rear surface side metal layer 51, and other part of the inner metal layers (the second inner metal layer 82 and the fourth inner metal layer 84) electrically connected to the second front surface side metal layer 42 and the second rear surface side metal layer 52 are electrically separated. Thus, any electric current path is not formed between the driving IC 11 and the light emitting element 10 by the metal layer.

Here, a material of the insulation layer described above is a fiber-containing resin material called “prepreg”, but the material of the resin layer is not limited to the specific resin material, and a material other than the prepreg such as epoxy resin, glass epoxy resin or the like may be adopted. Further, a material of the metal layer described above is copper, but the material of the metal layer is not limited to the specific metal material.

The thermal vias described above are formed as solid vias, each of which is made of a metal material filled in a through hole formed in the multilayer substrate. However, the solid vias can be replaced with hollow vias, each of which is made of a metal film formed on an inner peripheral surface of the through hole.

An area of the first front surface side metal layer and an area of the first rear surface side metal layer according to the embodiment described above are the same to each other, and an area of the second front surface side metal layer and an area of the second rear surface side metal layer are the same to each other. However, a heat dissipating effect can be enhanced by setting the area of the first rear surface side metal layer to be larger than the area of the first front surface side metal layer or by setting the area of the second rear surface side metal layer to be larger than the area of the second front surface side metal layer. Further, a thickness of each of the metal layers may be set to be different from each other in order for the similar object.

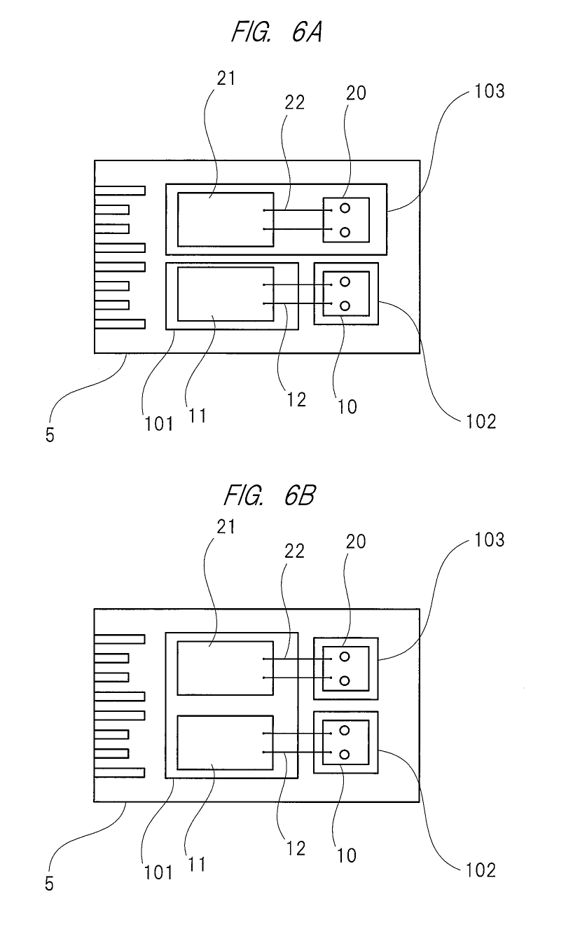

In the embodiment shown in FIG. 3, the driving IC 11, the amplifying IC 21, and the light receiving element 20 are mounted on the same metal layer (the first front surface side metal layer 41). However, the present invention is characterized in that the metal layer (the second front surface side metal layer 42) on which the light emitting element 10 is mounted is electrically separated from the metal layer on which other optical element or electronic part is mounted. Thus, mounting the driving IC 11, the amplifying IC 21 and the light receiving element 20 on the same metal layer is not necessary. For example, as shown in FIG. 6A, a first front surface side metal layer 101, a second front surface side metal layer 102, and a third front surface side metal layer 103 electrically separated from each other may be provided; the driving IC 11 may be mounted on the first front surface side metal layer 101; the light emitting element 10 may be mounted on the second front surface side metal layer 102; and the amplifying IC 21 and the light receiving element 20 maybe mounted on the third front surface side metal layer 103. Further, as shown in FIG. 6B, the driving IC 11 and the amplifying IC 21 may be mounted on the first front surface side metal layer 101; the light emitting element 10 may be mounted on the second front surface side metal layer 102; and the light receiving element 20 may be mounted on the third front surface side metal layer 103. In these cases, a rear surface side metal layer corresponding to each of the front surface side metal layers 101 to 103 may be provided independently. Alternatively, a rear surface side metal layer which is common to the first front surface side metal layer 101 and the third front surface side metal layer 103, and another rear surface side metal layer which corresponds to the second front surface side metal layer 102 may be provided. Further, since an amount of heating through the light receiving element 20 is less than that of the light emitting element 10, the rear surface side metal layer which corresponds to the light receiving element 20 may be omitted.

What is claimed is:

1. A communication module comprising:
a multilayer substrate;
an electronic part and an optical element mounted on the multilayer substrate;
a first front surface side metal layer provided on a front surface of the multilayer substrate;
a second front surface side metal layer provided on the front surface of the multilayer substrate and electrically separated from the first front surface side metal layer;
a first rear surface side metal layer provided on a rear surface of the multilayer substrate;
a second rear surface side metal layer provided on the rear surface of the multilayer substrate and electrically separated from the first rear surface side metal layer;
a first thermal via which is bored through the multilayer substrate and thermally connects the first front and rear surface side metal layers; and
a second thermal via which is bored through the multilayer substrate and thermally connects the second front and rear surface side metal layers,
wherein the electronic part is mounted on and thermally connected to the first front surface side metal layer, and
the optical element is mounted on and thermally connected to the second front surface side metal layer.

2. The communication module according to claim 1, wherein the optical element is formed as a light emitting element, and the electronic part is formed as a driving IC which drives the light emitting element.

3. The communication module according to claim 1, further comprising a plurality of insulation layers and inner metal layers alternately laminated between the first front and rear surface side metal layers and between the second front and rear surface side metal layers,
wherein one part of the inner metal layer electrically connected to the first front and rear surface side metal layers is electrically separated from the other part of the inner metal layer electrically connected to the second front and rear surface side metal layers.

4. The communication module according to claim 2, further comprising a plurality of insulation layers and inner metal layers alternately laminated between the first front and rear surface side metal layers and between the second front and rear surface side metal layers,
wherein one part of the inner metal layer electrically connected to the first front and rear surface side metal layers is electrically separated from the other part of the inner metal layer electrically connected to the second front and rear surface side metal layers.

5. The communication module according to claim 1, further comprising:
a third front surface side metal layer provided on the front surface of the multilayer substrate and electrically separated from the first and second front surface side metal layers; and
a light receiving element mounted on and thermally connected to the third front surface side metal layer.

6. The communication module according to claim 2, further comprising:
a third front surface side metal layer provided on the front surface of the multilayer substrate and electrically separated from the first and second front surface side metal layers; and
a light receiving element mounted on and thermally connected to the third front surface side metal layer.

7. The communication module according to claim 3, further comprising:
a third front surface side metal layer provided on the front surface of the multilayer substrate and electrically separated from the first and second front surface side metal layers; and
a light receiving element mounted on and thermally connected to the third front surface side metal layer.

8. The communication module according to claim 4, further comprising:
a third front surface side metal layer provided on the front surface of the multilayer substrate and electrically separated from the first and second front surface side metal layers; and
a light receiving element mounted on and thermally connected to the third front surface side metal layer.
